(19) United States
(12) Patent Application Publication
(10) Pub. No.: US 2007/0206581 A1
(43) Pub. Date: Sep. 6, 2007

(54) Method and apparatus for data recording multimedia data

(75) Inventor: Gung-eun Nam, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/601,694

(22) Filed: Nov. 20, 2006

(30) Foreign Application Priority Data
Mar. 3, 2006 (KR) 10-2006-0020385

(51) Int. Cl. H04L 12/66

(52) U.S. Cl. 370/356

(57) ABSTRACT

A multimedia event recording apparatus, and more particularly, a multimedia event recording method by which multimedia data and multimedia event contents are related and then stored, and an apparatus suitable for the method are provided. The multimedia recording method includes: detecting an occurrence of a control event in relation to multimedia data; closing a file in which an audio and/or video (A/V) stream is being recorded if the control event occurs, before the control event occurs is recorded; recording a position of data at which the control event corresponding to the closed file occurs and file information of the closed file in a mark table; and opening a new file and storing an A/V stream after the control event occurs.

### CROSS-REFERENCE TO RELATED PATENT APPLICATIONS

This application claims priority from Korean Patent Application No. 10-2006-0020385, filed on Mar. 3, 2006, in the Korean Intellectual Property Office, the disclosure of which is incorporated herein in its entirety by reference.

### BACKGROUND OF THE INVENTION

1. Field of the Invention

Methods and apparatuses consistent with the present invention relate to multimedia recording, and more particularly, to multimedia recording by which multimedia data and multimedia contents are related and then stored.

2. Description of the Related Art

A video conference system enables a conference to be performed with participants in remote places by exchanging their images and voices through communication lines.

In a related video conference system, an apparatus to record the contents of a video conference is provided in order to save the contents of a conference.

However, the related video conference recording apparatus records the entire contents of a conference from the beginning to the end of the conference in a single file such that it is not easy to identify a particular portion of the conference when the contents of the conference are retrieved later.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

An aspect of the present invention is to provide a multimedia recoding method by which multimedia data is recorded in synchronization with a control event in relation to multimedia data so that the multimedia data can be retrieved efficiently.

An aspect of the present invention is to provide a multimedia terminal suitable for the multimedia recording method.

According to an aspect of the present invention, there is provided a multimedia recording method including: detecting an occurrence of a control event in relation to a multimedia data stream; closing a first file in which the multimedia data stream is being recorded before recording the occurrence of the control event, and opening a second file and recording the multimedia data stream in the second file after the occurrence of the control event.

According to another aspect of the present invention, there is provided a multimedia terminal including: an interface unit that receives a multimedia data stream; and a recording control unit that records the multimedia data stream received by the interface unit in a first file, closes the first file, if the control event related to the multimedia data stream occurs, before recording the occurrence of the control event, and opens a second file and records the multimedia data stream in the second file after the control event occurs.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram illustrating a structure of a multimedia terminal adapting a multimedia recording method according to an exemplary embodiment of the present invention;

FIG. 2 is a schematic diagram illustrating a method of recording a multimedia event according to an exemplary embodiment of the present invention;

FIG. 3 illustrates an example of a mark table according to an exemplary embodiment of the present invention;

FIG. 4 is a schematic diagram illustrating a method of recording a multimedia event according to another exemplary embodiment of the present invention;

FIG. 5 illustrates another example of a mark table according to an exemplary embodiment of the present invention; and

FIG. 6 illustrates an example of a screen displayed on a multimedia terminal shown in FIG. 1.

### DETAILED DESCRIPTION OF THE EXEMPLARY EMBODIMENTS OF THE INVENTION

The present invention will now be described more fully with reference to the accompanying drawings, in which exemplary embodiments of the invention are shown.

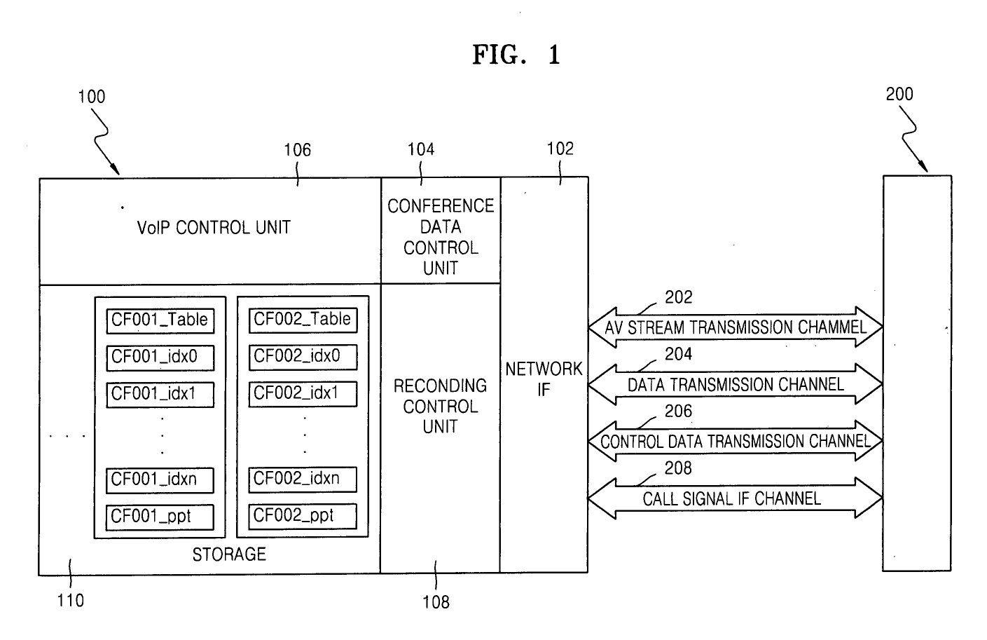

FIG. 1 is a block diagram illustrating a structure of a multimedia terminal adapting a multimedia recording method according to an exemplary embodiment of the present invention. Hereinafter, exemplary embodiments of the present invention will be described for a case in which a video conference is performed. However, the present invention is not limited to a video conference, but instead may be applied to recording of any type of multimedia data.

In FIG. 1, the multimedia terminal is shown as a video conference terminal 100 which includes a network interface unit 102, a conference data control unit 104, a voice over internet protocol (VoIP) control unit 106, a recording control unit 108, and a storage medium 110.

Video conference terminals 100 and 200 perform a video conference through an audio/video (A/V) stream transmission channel 202 for transmitting images and voice, respectively, a data transmission channel 204 for transmission and sharing of video conference data, a control channel 206 for sharing control information of video conference data, and a call signal interface channel 208. The apparatus illustrated in FIG. 1 provides an H.323-based video conference system.

H.323 is a recommendation to allow a user to communicate with another user in another network while maintaining an existing structure without any network-related changes.

Accordingly, the applications of H.323, including a multimedia video conference among departments, communications among different websites, and cheap long distance telephony through a packet switched network, have been gradually increased.

In H.323, an information stream includes video, audio, communication control and call control signals. The audio signal includes digitized and encoded voice information and the video signal includes digitized and encoded moving picture information. Meanwhile, the data signal includes streams for still images, facsimiles, documents, and computer files. The communication control signal is used for exchanging of the capacities of elements having similar functions but positioned at remote places, opening and closing of a logic channel, and controlling of a mode. The call control signal is used for call control functions, such as setting of a call, connection of a call, and termination of a call connection.

The network interface unit 102 performs interfacing of an A/V stream, data, data control signals, and call control signals among terminals 100 and 200.

The conference data control unit 104 controls transmission of data through the network interface unit 102. The conference data control unit 104 extracts conference data and provides the data to the recording control unit 108. The VoIP control unit 106 performs controls for conducting a conference, i.e., transmission of an A/V stream and data, and control of calls.

The recording control unit 108 stores an A/V stream provided by the network interface unit 102 and conference data provided by the conference data control unit 104. Here, the recording control unit 108 stores the A/V stream and conference data in synchronization with a control event in relation to the conference data and an event by a user, and generates a mark table having mapping information in relation to these events, a plurality of A/V stream files, and conference data. Also, the recording control unit 108 controls such that A/V stream files related to an event can be retrieved by referring to a mark table when the contents of a conference are retrieved and by doing so, contents related to a requested part can be easily retrieved from the stored contents of the conference.

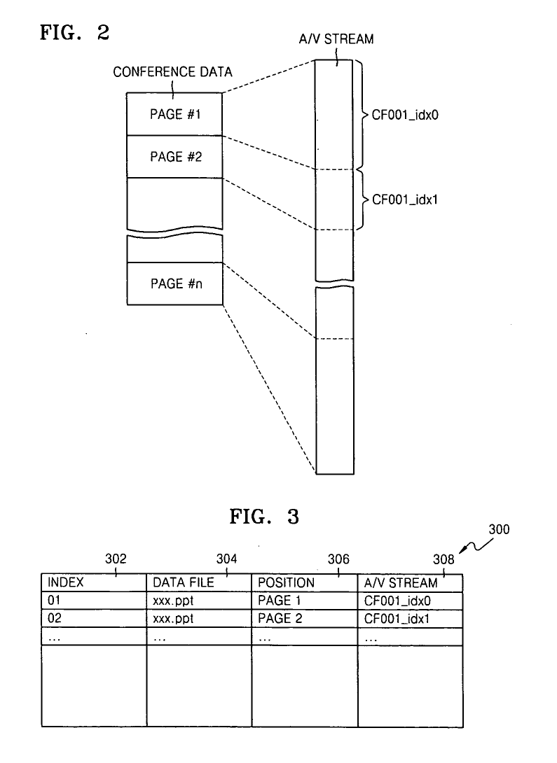

FIG. 2 is a schematic diagram illustrating a method of recording a video conference according to an exemplary embodiment of the present invention. Referring to FIG. 2, an A/V stream showing the contents of a conference is divided with respect to control events and recorded. For example, if the conference data (document) is made up with n pages and an A/V streams is divided and recorded as a page is turned, A/V streams are divided into n A/V stream files corresponding to respective pages and recorded.

The VoIP control unit 106 monitors an occurrence of a control event with respect to the conference data provided through the control channel 206. In the present invention, an example of a control event is turning of a page.

A control event indicating turning of a page of the conference data may occur in a host terminal and this event is transmitted to client terminals. In response to this, the client terminals display the next page on screens (not shown) of the terminals.

This control event with respect to the conference data occurs as the conference is proceeding, and can be an important factor that can classify the contents of the conference. Accordingly, in the present invention, A/V streams showing the contents of a conference are divided according to a control event in relation to the conference data, and according to the turning of a page, in particular, and recorded such that the contents of the conference can be easily retrieved later.

If an occurrence of a control event in relation to conference data is detected, the recording control unit 108 closes a file in which the A/V stream before the occurrence of the control event, and records the position of data at which a control event corresponding to the closed file, and the file information of the closed file in the mark table.

Here, the position of the data includes at least a page number, and the file information includes at least a file name.

FIG. 3 illustrates an example of a mark table according to an embodiment of the present invention. Referring to FIG. 3, the mark table 300 includes an index 302, a data file name 304, a page number 306, and a file name 308. The mark table 300 is disposed in each video conference. That is, one video conference file includes the mark table 300 and a plurality of A/V stream files. A user can retrieve the content of the conference by referring to the page number 306 recorded in the mark table 300 later. Referring to FIG. 3, if a control event in relation to conference data occurs, for example, if an event of turning a page occurs, an A/V stream file in relation to the previous page is closed and the page number and the name of the A/V stream file are recorded in the mark table such that the contents of the conference can be retrieved according to the conference data and page number.

The recording control unit 208 opens a new file and stores an A/V stream after the control event occurs.

During the process of the conference, detection of a control event, recording information in the table and storing the file are continuously and repeatedly performed so that A/V stream files corresponding to one video conference and the mark table in which file information of the A/V stream files and positions of data are recorded.

Referring to FIGS. 2 and 3, the example of storing A/V streams with respect to the page of the conference data are shown but the present invention is not limited to this exemplary embodiment.

For example, according to the present invention, an A/V stream may be recorded according to a control event set by a client. A conference participant may want to record the conference from a time when he/she thinks to be important regardless of the page number of the conference data. In response to this request, a recording operation may be performed by a control event by a user.

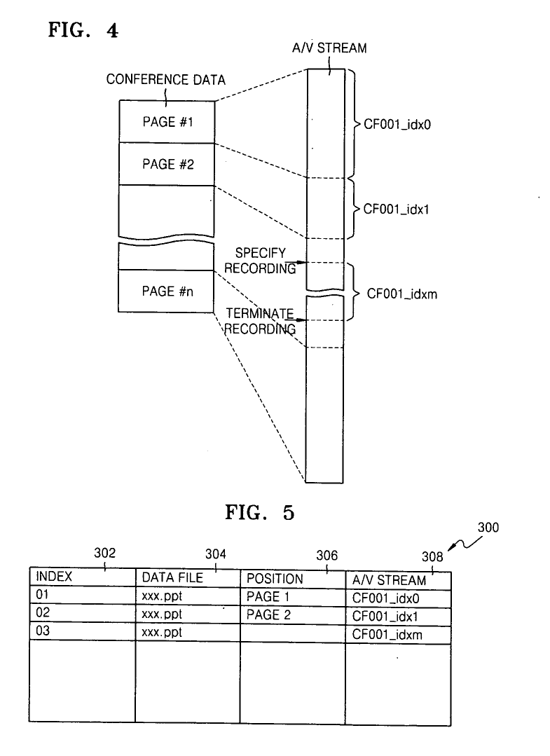

FIG. 4 is a schematic diagram illustrating a method of recording a video conference according to another exemplary embodiment of the present invention. Referring to FIG. 4, an A/V stream is divided and recorded not only by a control event, for example, turning a page, but also by a control event set by a user. A conference participant can generate a recording command at a part which the participant thins to be important, and an A/V stream after the recording command is generated is recorded in a separate file.

The VoIP control unit 106 monitors an occurrence of a control event by a user. In the present invention, a recording command is shown as an example of a control event by a user. If the control event by a user (a user control event) occurs, a new file is opened and an A/V stream after the user control event occurs is stored.

After that time, if the user control event is terminated, the file corresponding to the event is closed and the index (or mark) of the user control event and the file information of the closed file are recorded in the mark table. Here, the index is generated in order that the event is recorded in the mark table and the mark is a name given by the user in relation to the A/V stream file. This name may be given as a default by the terminal 100 and 200.

FIG. 5 illustrates another example of a mark table according to an exemplary embodiment of the present invention. Referring to FIG. 5, it can be seen that in addition to the file information corresponding to the control event in relation to the conference data, file information corresponding to the user control event is also recorded. Here, it can be seen that mark and file information corresponding to the user control event are recorded.

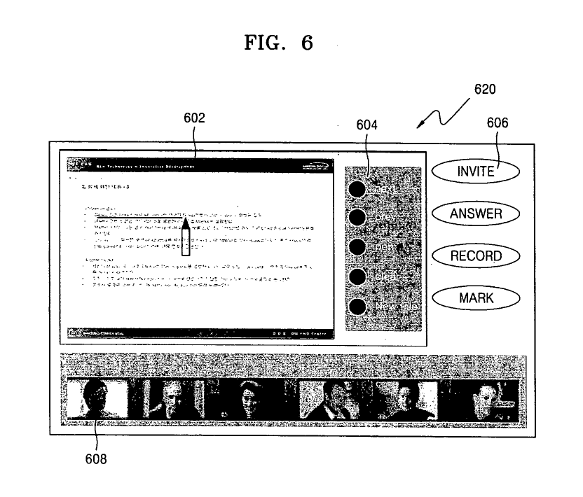

FIG. 6 illustrates an example of a screen displayed on a video conference terminal shown in FIG. 1. The screen 600 displayed on the video conference terminal 100 and 200 is composed of a data display area 602, a data control panel 604, a conference control panel 606, and a conference participant display area 608.

The data display area 602 is an area displaying conference data, and may display conference data with respect to pages.

The data control panel 604 includes buttons to generate a control event in relation to conference data, and control events includes ‘next (turning a page)’, ‘pre (turning back to a previous page)’, ‘pen (marking an important part)’, ‘clear’, and ‘new file’.

The conference control panel 606 includes ‘invite (invitation for conference participation)’, ‘answer’, ‘record’, and ‘mark (user-specified recording)’. Here, ‘record’ is provided in order to indicate to start or end recording of an A/V stream according to a control event in relation to the conference data, and ‘mark (user-specified recording)’ is provided to specify a user control event, i.e., recording when user needs it.

The participant display area 608 is to display participants participating in the video conference.

According to the method of recording a video conference, the contents of a conference are divided according to a control event and recorded. This divisional recording method enables retrieval of the contents of a conference to be faster and easier.

It can be considered that the contents of a conference are stored in one A/V stream such that a time when a control event in relation to conference data occurs corresponds to the position of the data. However, in this case, the start position of a file in relation to each conference data item should be retrieved sequentially and may increase a retrieval time. Accordingly, in the present invention, by generating a separate A/V stream file in each position of conference data, conference data can be randomly retrieved and the retrieval time can be reduced.

According to the video conference recording method of the present invention, by storing the contents of one conference as a plurality of files having an index, and by mapping the index to conference data or making a user specify conference data, contents related to a desired part can be easily retrieved later from the conference contents.

Accordingly, the present invention provides a multimedia data recording method which detects an occurrence of a control event relating to a multimedia data stream, closes a first file in which the multimedia data stream is being recorded, before recording the occurrence of the control event, and opens a second file and records the multimedia data stream in the second file after the occurrence of the control event.

Further, the present invention provides a multimedia terminal which comprises an interface unit which receives a multimedia data stream, and a control unit which records the multimedia data stream received by the interface unit in a first file, closes the first file data, if a control event related to the multimedia data stream occurs, before recording the occurrence of the control event, and opens a second file and records the multimedia data stream in the second file after the control event occurs.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A multimedia data recording method comprising:
detecting an occurrence of a control event in relation to a multimedia data stream;
closing a first file in which the multimedia data stream is being recorded before recording the occurrence of the control event; and
opening a second file and recording the multimedia data stream in the second file after the occurrence of the control event.

2. The method of claim 1, wherein the recording of the multimedia data stream is continuously performed such that at least two files corresponding to the multimedia data stream are obtained.

3. The method of claim 1, further comprising recording at least one of position information at which the control event corresponding to the recorded multimedia data stream occurs and information for the recorded multimedia data stream.

4. The method of claim 2, further comprising recording at least one of position information at which the control event corresponding to the recorded multimedia data stream occurs and information for the recorded multimedia data stream..

5. The method of claim 1, wherein the control event is a turning of a page of the multimedia data.

6. The method of claim 1, further comprising:
wherein the closing the first file comprises recording a name of the user control event corresponding to the first file and file information of the first file in a mark table.

7. A multimedia terminal comprising:
an interface unit which receives a multimedia data stream; and
a control unit which records the multimedia data stream received by the interface unit in a first file, closes the first file, if a control event related to the multimedia data stream occurs, before recording the occurrence of the control event, and opens a second file and records the multimedia data stream in the second file after the control event occurs.

8. The multimedia terminal of claim 7, wherein the control unit records the multimedia data stream continuously such that at least two file corresponding to the multimedia data stream are obtained.

9. The multimedia terminal of claim 7, wherein the control unit records at least one of position information at which the control event corresponding to the recorded multimedia data stream occurs and information for recorded multimedia data stream.

10. The multimedia terminal of claim 8, wherein the control unit records at least one of position information at which the control event corresponding to the recorded multimedia data stream occurs and information for recorded multimedia data stream.

11. The multimedia terminal of claim 7, further comprising a multimedia data control unit which controls transmission of the multimedia data stream through the interface unit.

12. The multimedia terminal of claim 11, further comprising a voice over internet protocol (VoIP) control unit which detects the occurrence of the control event.

13. The multimedia terminal of claim 7, wherein the recording control unit records a position of the multimedia data stream corresponding to the occurrence of a control event.

14. The multimedia terminal of claim 13, wherein the control unit generates a mark table in which the multimedia data stream files and the positions of the multimedia data stream at the occurrence of the control event are recorded.

15. The multimedia terminal of claim 14, wherein the control unit records the multimedia data stream files and the mark table in a recording medium.
